(19) United States
(12) Patent Application Publication
(10) Pub. No.: US 2009/0256275 A1
(43) Pub. Date: Oct. 15, 2009

(54) THERMOMECHANICALLY-ACTIVATED TIP SHAPE AND REGISTRY RESTORATION FOR PROBE ARRAY DEVICES UTILIZING THERMOMECHANICALLY-ACTIVATED POLYMERS

(75) Inventors: Rachel Cannara, Adliswil (CH); Bernd W. Gotsmann, Horgen (CH); Urs T. Duerig, Rueschlikon (CH); Harish Bhaskaran, Thalwil (CH); Armin W. Knoll, Adliswil (CH)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/100,364

(22) Filed: Apr. 9, 2008

(51) Int. Cl. B28B 3/00

(52) U.S. Cl. 264/36.18; 264/241

(57) ABSTRACT

A method of repairing worn or blunt probe tips, attaching a desired tip material, or defining the registry of probe tips relative to planar surface, including: pressing a probe tip or an array of probe tips into a substrate pre-patterned with an array of tip-shaped molds, the molds containing a preceramic material that can bond to the worn probe tips by thermal activation, the substrate having a protective layer that prevents the preceramic material and/or thermally-activated ceramic material from bonding to the substrate; pressing the worn probe tips into the molds while heating the worn probe tips causing the preceramic material to bond to the worn probe tips and form a solid ceramic material; forming an array comprising a plurality of reconstructed probe tips that are sharper or consisting of a different material than the original worn or base probe tips; and reading and/or writing, with the array comprising the plurality of reconstructed probe tips, data that was unreadable and/or unwritable with the original probe tips due to tip shape or lack of registry with a planar pattern.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to a method and apparatus for thermomechanically-activated tip shape restoration, tip material definition, and tip registry creation or restoration for probe array devices utilizing preceramic materials and to probe tips created, defined and/or restored by such method and apparatus.

(2) Description of Related Art Including Information Submitted under 37 CFR 1.97 and 1.98

Allenspach et al. (U.S. Pat. No. 6,680,808) is representative of a magnetic millipede for ultra high density magnetic storage. According to the Allenspach et al. abstract, “a two-dimensional array of cantilevered tips . . . is advantageously used in an inventional storage system each of which tips serves as a heat source when it is activated by a current flowing through a resistive path within said tip . . . ”

Doezema et al. (U.S. Pat. No. 6,139,759) discloses a method of manufacturing silicided silicon microtips for scanning probe microscopy that includes “depositing a refractory metal on the silicon tip, heating the cantilever and tip combination in an ambient free of oxygen to react chemically the refractory metal on and the silicon of the tip” (see the Doezema et al. abstract).

Lindsay et al. (U.S. Pat. No. 6,017,590) discloses tip coating for scanning probe microscopy.

Bianconi et al. (U.S. Pat. No. 6,989,428) discloses “silicon carbide (SiC) ceramics that can be produced from poly(methylsilyne), as well as other ceramics, which can be produced from these precursors” (see the Bianconi et al. abstract). Also see U.S. Patent Publication No. 2004/0010108 to Bianconi et al.

### BRIEF SUMMARY OF THE INVENTION

At least some aspects of this disclosure are directed to thermomechanically-activated tip shape, material and registry creation, definition, and/or restoration for probe array devices utilizing preceramic materials.

At least some other aspects and embodiments of this disclosure are directed to a probe or probes having a tip or set of tips formed by the methods of the various aspects and embodiments of this disclosure.

In particular, at least some aspects of this disclosure are directed to a method of repairing one or more worn or blunt probe tips, including: inserting a probe tip or an array of probe tips comprising blunt, worn probe tip(s) into a substrate pre-patterned with tip-shaped mold(s), the mold(s) containing a preceramic material that can bond to the worn probe tip(s), the substrate having a protective layer that prevents the preceramic material and/or subsequent thermally-activated ceramic material from bonding to the substrate; pressing the probe tip(s) into the mold(s) while heating the probe tip(s) causing the preceramic material to bond to the worn probe tip(s) and form a solid ceramic material; and reading and writing, with the tip or tip array comprising (re)constructed probe tips, data that was previously unreadable or unwritable with the original probe tip(s).

At least some other aspects of this disclosure are directed to a method of restoring or creating registry of one or more probe tips with respect to a desired surface pattern, including using the method described above to form an array including at least one reconstructed probe tip that is sharper or of different material than the original or worn probe tip(s); and reading and writing with the probe tip array comprising (re)constructed probe tips data that was previously unreadable or unwritable with the original probe tip(s).

At least some other aspects and embodiments of this disclosure are directed to an apparatus for (re)constructing probe tips, including a substrate having a protective layer upon which is a preceramic material that can bond to the original tip.

More particularly, at least some aspects and embodiments of this disclosure are directed to a method of forming at least one sharp and wear-resistant probe tip, including: inserting at least one original probe tip, the at least one original probe tip being a worn tip, blunt tip, or a tip made of a material softer than or less wear-resistant than ceramic material, into a substrate pre-patterned with a tip-shaped mold or mold of a desired geometry, the mold containing a preceramic material that can bond to the at least one original probe tip, the substrate optionally having a protective layer that prevents the preceramic material from bonding to the substrate; and pressing the at least one original probe tip into the mold while heating the at least one original probe tip causing the preceramic material to bond to the at least one original probe tip and to form a solid ceramic material. In at least some embodiments, the method can further include creating or restoring a defined registry pattern of an array of probe tips, by: forming a plurality of individual tips; each of the plurality of tips having a corresponding mold; where each mold is part of a predefined planar layout with respect to the array to define the registry pattern.

Other exemplary embodiments and advantages of this disclosure can be ascertained by reviewing the present disclosure and the accompanying drawing.

### BRIEF DESCRIPTION OF THE SEVERAL VIEWS OF THE DRAWING(S)

This disclosure is further described in the detailed description that follows, with reference to the drawings, in which:

FIG. 1 illustrates a probe tip undergoing a process of registry restoration in accordance with at least some aspects and embodiments of this disclosure;

FIGS. 2A, 2B, and 2C illustrate a method of repairing a worn or blunt tip in accordance with at least some aspects and embodiments of this disclosure; and

FIG. 3 illustrates a method of repairing a pair of worn or blunt tips in accordance with at least some aspects and embodiments of this disclosure.

### DETAILED DESCRIPTION OF THE INVENTION

Exemplary embodiments of this disclosure are described herein by way of example.

For thermomechanical probe storage, several factors can be helpful to maintain overall device reliability for both write and read functions. Examples of these factors can include bit retention, uniform/homogeneous media, and tip shape stability, all of which can be beneficial for storage applications.

Wear of the tip during the read and write process can pose a challenge for probe storage with regard to data storage applications. The tip cannot be resharpened during the course of the lifetime of the device.

At least some embodiments of this disclosure are directed to a method that can utilize a thermolysis procedure to create or restore sharpness to worn tips or to or define tip shape or tip material.

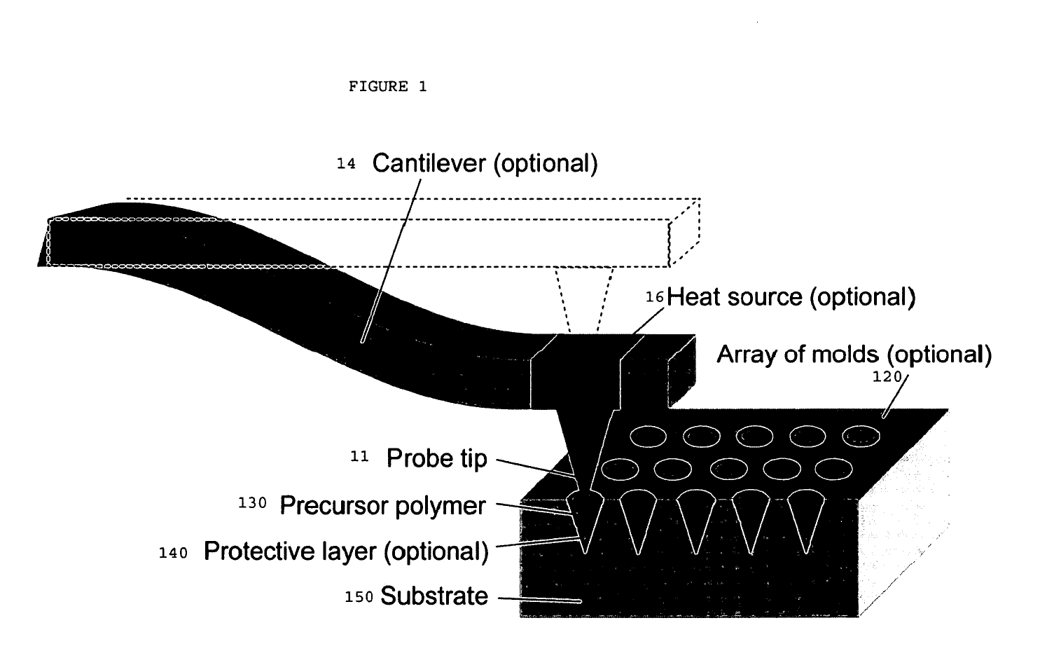

FIG. 1 shows a probe tip 11 connected to a cantilever 14 having a heat source 16. FIG. 1 also shows an array 120 of molds formed in a substrate 150, the molds containing a precursor polymer 130 and the molds protected from bonding to the precursor polymer 130 by an optional protective layer 140.

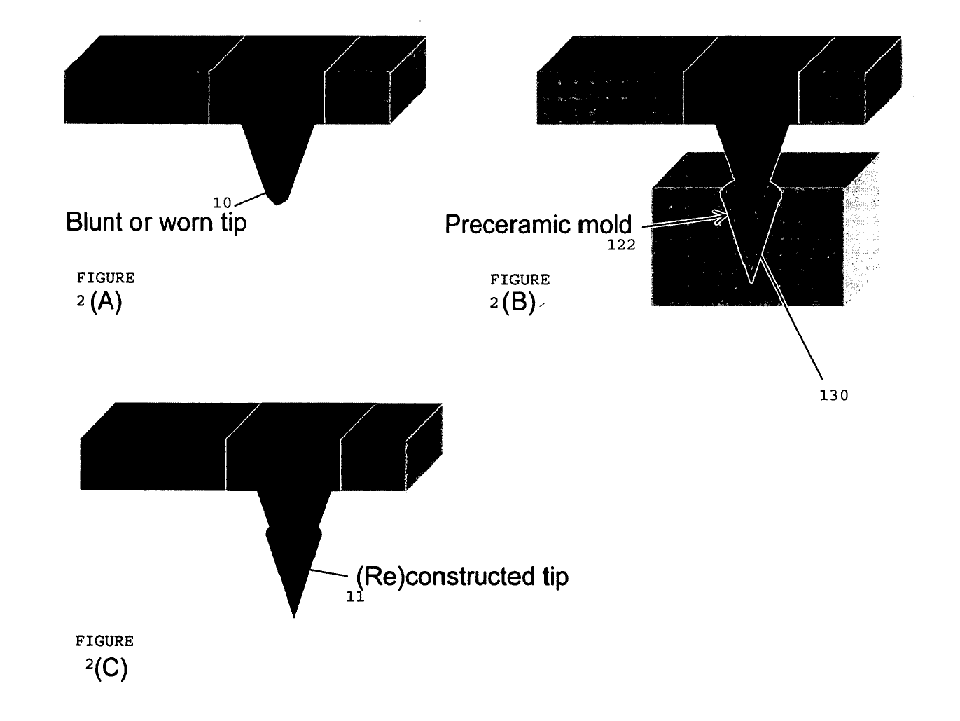

Now referring to FIGS. 2A, 2B, and 2C, tips such as blunt or worn probe tip 10 (FIG. 2A) can be (re)constructed or otherwise defined to form a (re)constructed tip such as (re)constructed tip 11 by indenting the tip 10 into a pre-patterned area containing a preceramic polymer (or polymer precursor) 130 in a mold 122 via a thermolysis process that transforms the polymer 130 into a hardened, ceramic material. This process can be achieved by a chemical reaction with a prescribed activation energy supplied by the heat and/or pressure applied by the nanoscale probe tip 10/11.

The reaction can result in a permanent transformation or phase change of the material (transforming the relatively soft polymer toward a defined stoichiometric ceramic state). Depending on the composition of the polymer precursor 130, the resulting (re)constructed tip 11 material can be extremely hard and wear-resistant, so that subsequent tip-restoration procedures can remain infrequent.

For example, polymethylsilyne (PMSy) is a high molecular weight preceramic polymer that forms silicon carbide in inert (e.g., argon) or chemically-active (e.g., ammonia) environments at temperatures above 200° C. and pressures of 1 atm or above. PMSy was discovered recently to be a superior polymer precursor for silicon carbide materials, due to its high yield (of SiC from polymer) and its production of near-stoichiometric, defect-free SiC. Other precursor materials also exist.

The appropriate precursor material (and forming environment) for a given application can depend on specifications, including whether the tip should be electrically conducting or insulating, crystalline or amorphous, etc.

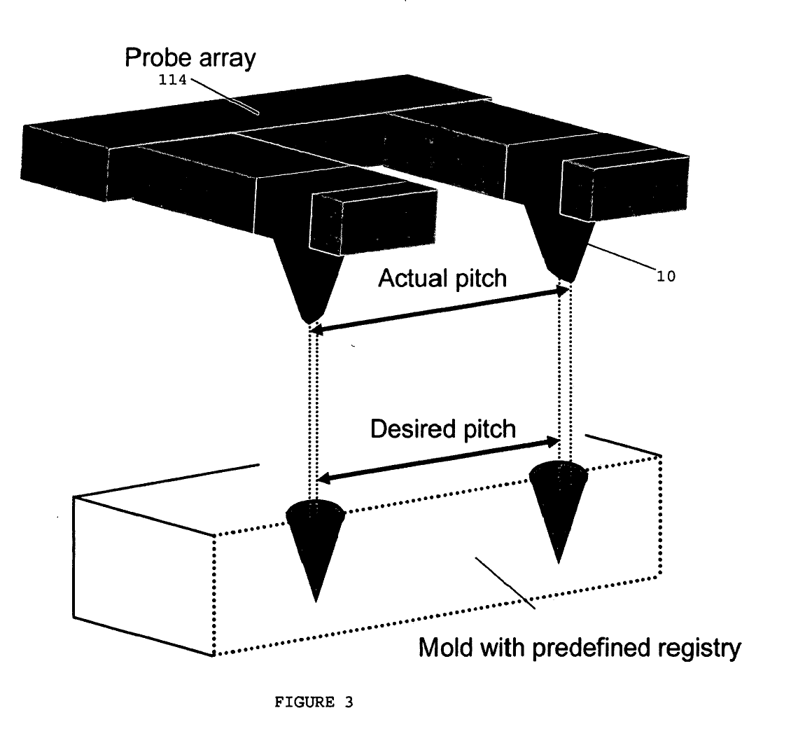

FIGS. 2 and 3 show a cross-sectional view of a probe or probes having a probe tip 10 undergoing a process of shape (FIG. 1) and registry (FIG. 2) restoration according to at least some aspects and embodiments of the method of this disclosure.

A mold structure can be constructed to mimic the shape and/or location of a single tip or array of probe tips. The geometry of the tip-shaped cavities in the mold and the spacing between them (if applicable for an array) represent the desired tip-shape/sharpness and/or relative surface registry (e.g., when the initial bits were written for data storage, or structures written for scanned probe lithography. The film layer structure (protective layer 140+preceramic polymer 130) is reversed to prevent bonding of ceramic to the substrate 150. With the protective layer 140 separating the preceramic polymer 130 from the substrate 150, the thermolysis step can bond the preceramic polymer 130 to the tip. This serves to form or rebuild the worn tip 10, forming a tip 11 having a sharp apex or one consisting of a desired material (e.g., a hard, wear-resistant material). In addition, a probe array 114 can lose registry with the surface due to asymmetric tip wear. This tip reforming process can restore the original registry with data written before tip changes occurred, as illustrated by FIG. 3.

Thus, in accordance with embodiments of the method of this disclosure, a worn tip 10 can be pressed into a pre-patterned array of molds 120 in a substrate 150 containing a preceramic material 130 that bonds to the tip 10 and forms a new, sharper tip 11 upon thermolysis. In the case of a probearray 114 of probe tips, registry with data written before the tip was blunted or registry altered can be made readable once again via this procedure.

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A method of forming at least one sharp and wear-resistant probe tip, comprising:
inserting at least one original probe tip, the at least one original probe tip being a worn tip, blunt tip, or a tip made of a material softer than or less wear-resistant than ceramic material, into a substrate pre-patterned with a tip-shaped mold or mold of a desired geometry, the mold containing a preceramic polymer or polymer precursor material that can bond to the at least one original probe tip, the substrate having a protective layer that prevents the preceramic polymer or polymer precursor material from bonding to the substrate; and
pressing the at least one original probe tip into the mold while heating the at least one original probe tip causing the preceramic polymer or polymer precursor material to bond to the at least one original probe tip and to form a solid ceramic material;
wherein the heat is applied by the at least one original probe tip.

2. The method of claim 1, further comprising creating or restoring a defined registry pattern of an array of probe tips, by:
forming a plurality of individual tips;
each of the plurality of tips having a corresponding mold;
wherein each mold is part of a predefined planar layout with respect to the array to define the registry pattern.
